(19) United States
(12) Patent Application Publication
(10) Pub. No.: US 2026/0200293 A1
(43) Pub. Date: Jul. 16, 2026

(54) TEMPERATURE ADJUSTMENT CIRCUIT

(71) Applicant: HONDA MOTOR CO., LTD., Tokyo (JP)

(72) Inventors: Satoki UEMATSU, Tokyo (JP); Takuro KOTO, Tokyo (JP); Naoya YOKOTA, Tokyo (JP)

(73) Assignee: HONDA MOTOR CO., LTD., Tokyo (JP)

(21) Appl. No.: 19/443,053

(22) Filed: Jan. 8, 2026

(30) Foreign Application Priority Data
Jan. 14, 2025 (JP) 2025-004773

(51) Int. Cl. B60H 1/32; B60H 1/00

(52) U.S. Cl. CPC B60H 1/32281; B60H 1/00899; B60H 2001/00928

(57) ABSTRACT

A temperature adjustment circuit has two refrigeration cycles, a heat exchange circuit, and a temperature adjustment target of which temperature is adjusted by the heat exchange circuit. The first refrigeration cycle includes a first compressor compressing a first refrigerant, a first heat exchanger exchanging heat with the compressed first refrigerant, a first expansion valve decompressing the first refrigerant passing through the first heat exchanger, and a second heat exchanger exchanging heat with the first refrigerant passing through the first heat exchanger. The second refrigeration cycle includes a second compressor compressing a second refrigerant, a third heat exchanger exchanging heat with the compressed second refrigerant, a second expansion valve decompressing the second refrigerant passing through the third heat exchanger, and a fourth heat exchanger exchanging heat with the second refrigerant passing through the third heat exchanger. The heat exchange circuit performs heat exchange between the first and fourth heat exchangers.

### CROSS-REFERENCE TO RELATED APPLICATIONS

This application is based on and claims priority under 35 USC 119 from Japanese Patent Application No. 2025-004773 filed on January 14, 2025, the entire content of which is incorporated herein by reference.

### TECHNICAL FIELD

The present disclosure relates to a temperature adjustment circuit.

### BACKGROUND ART

In recent years, efforts to realize a low-carbon society or a decarbonized society become active, and it is required to reduce CO₂ emission and improve energy efficiency also in moving objects such as automobiles.

JP2013-113534A discloses a system in which two heat pump systems are combined, heat is absorbed from a heat source (outside air) by a low-stage cycle heat pump system, and the heat absorbed by the low-stage cycle is used as a heat source and is further absorbed by a high-stage cycle heat pump system to perform heating.

However, it is required to improve it from the viewpoint of improving operation efficiency of the temperature adjustment circuit.

### SUMMARY OF INVENTION

The present disclosure provides a temperature adjustment circuit capable of improving operation efficiency.

An aspect of the present disclosure is a temperature adjustment circuit having:

a first refrigeration cycle including:

a first compressor configured to compress and discharge a first refrigerant;

a first heat exchanger configured to perform a heat exchange with the first refrigerant compressed by the first compressor;

a first expansion valve configured to decompress the first refrigerant that has passed through the first heat exchanger; and

a second heat exchanger configured to perform a heat exchange with the first refrigerant that has passed through the first heat exchanger;

a second refrigeration cycle including:

a second compressor configured to compress and discharge a second refrigerant;

a third heat exchanger configured to perform a heat exchange with the second refrigerant compressed by the second compressor;

a second expansion valve configured to decompress the second refrigerant that has passed through the third heat exchanger; and

a fourth heat exchanger configured to perform a heat exchange with the second refrigerant that has passed through the third heat exchanger;

a first heat exchange circuit configured to perform a heat exchange between the first heat exchanger and the fourth heat exchanger; and

a temperature adjustment target of which temperature is adjusted by the first heat exchange circuit.

According to the aspect of the present disclosure, it is possible to provide the temperature adjustment circuit capable of improving operation efficiency. The aspect of the present disclosure further contributes to improvement of energy efficiency.

### BRIEF DESCRIPTION OF DRAWINGS

Exemplary embodiment(s) of the present invention will be described in detail based on the following figures, wherein:

FIG. 1 is a schematic configuration diagram of a vehicle V;

FIG. 2 illustrates an example of a temperature adjustment circuit 10 mounted on the vehicle V;

FIG. 3 illustrates an example of a cascade heating operation mode;

FIG. 4 illustrates an example of a single-stage heating + low-stage heating operation mode;

FIG. 5 illustrates an example of a single-stage heating operation mode;

FIG. 6 illustrates an example of specific control of the temperature adjustment circuit 10 by a control device 4; and

FIG. 7 is a flowchart illustrating an example of processing executed by the control device 4.

### DESCRIPTION OF EMBODIMENTS

Hereinafter, an embodiment according to the present disclosure will be described in detail below with reference to the drawings. The drawings are viewed in directions of reference numerals. Not all the elements to be described in the following embodiments are necessarily essential for the present invention. Hereinafter, the same or similar elements are denoted by the same or similar reference numerals, and the description thereof may be omitted or simplified as appropriate.

### Vehicle

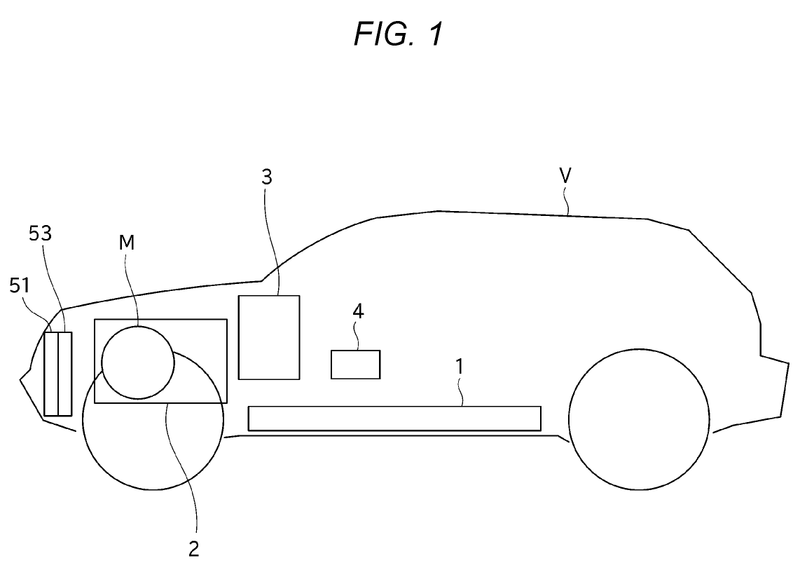

As illustrated in FIG. 1, a vehicle V, which is an example of a moving object, is an electric vehicle including a battery 1, a drive unit (DU) 2 that drives the vehicle V to travel by power supplied from the battery 1, a heating ventilation and air-conditioning (HVAC) 3 that controls air conditioning in a passenger compartment of the vehicle V, and a control device 4.

The drive unit 2 includes, for example, a motor M as a motor (so-called traction motor) that drives drive wheels of the vehicle V. The motor M is, for example, a three-phase AC motor, and may generate heat by operating. That is, the drive unit 2 may include a heat generation source.

The drive unit 2 may include an inverter or a DC-DC converter (DC: direct current) as a power conversion device that converts power exchanged between the battery 1 and the motor M, a charger that charges the battery 1 using power received from an external power supply, and the like. As another example, the inverter, the DC-DC converter, or the charger may be provided in the vehicle V in combination with the battery 1 as one unit. In this case, the "battery 1" in the following description may be replaced with a unit in which at least one of the inverter, the DC-DC converter, and the charger is combined with the battery 1.

The HVAC 3 is a system capable of cooling and heating the passenger compartment of the vehicle V, and includes, for example, a first refrigeration cycle 11 and a second refrigeration cycle 12 to be described later. In addition, in the front of the vehicle V (for example, in an engine room provided in a front portion of the vehicle V), a radiator 51 of a second heat exchange circuit 14 to be described later is provided, and an electric fan 53 that promotes heat dissipation and/or heat absorption thereof is also provided.

The control device 4 is a computer for integrally controlling the entire vehicle V, and is implemented by an electronic control unit (ECU) including, for example, a processor that performs various types of calculation, a memory that stores various types of information, and an interface (I/F) that controls input and output of data between inside and outside of the control device 4. As an example, the control device 4 controls a temperature adjustment circuit 10 to be described later to realize temperature adjustment of the battery 1 and/or the drive unit 2 and realize heating of the passenger compartment.

### Temperature Adjustment Circuit

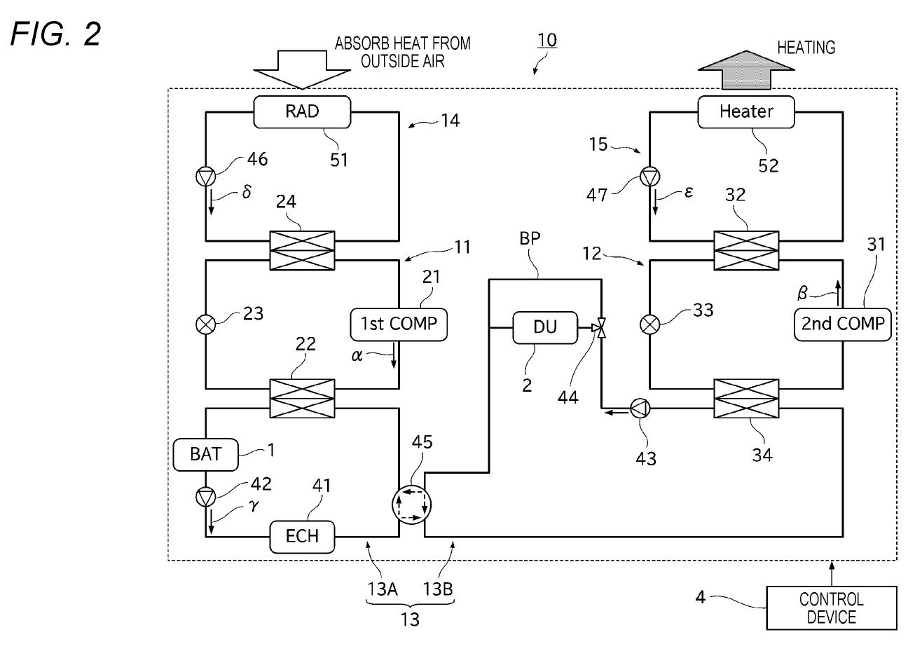

The vehicle V is equipped with the temperature adjustment circuit 10 illustrated in FIG. 2. As illustrated in FIG. 2, the temperature adjustment circuit 10 includes, for example, a first refrigeration cycle 11, a second refrigeration cycle 12, a first heat exchange circuit 13, a second heat exchange circuit 14, and a third heat exchange circuit 15. The temperature adjustment circuit 10 may include the control device 4 capable of controlling the entire temperature adjustment circuit 10.

The first refrigeration cycle 11 is a refrigeration cycle that allows a first refrigerant to circulate therethrough, and is operated under the control of the control device 4, for example. The first refrigerant is, for example, an air conditioner refrigerant such as HFC-134a or HFO-1234yf. A solid arrow α illustrated in FIG. 2 indicates a flow direction of the first refrigerant in the first refrigeration cycle 11.

The first refrigeration cycle 11 includes, for example, a first compressor (1st COMP) 21, a first heat exchanger 22, a first expansion valve 23, and a second heat exchanger 24.

The first compressor 21 is configured by, for example, an electric compressor, and compresses and discharges the first refrigerant. The first heat exchanger 22 is configured by, for example, a liquid cooled condenser (LCC), and performs a heat exchange between the first refrigerant compressed by the first compressor 21 and a third refrigerant flowing through the first heat exchange circuit 13 to be described later. That is, the first heat exchanger 22 can perform a heat exchange with the first refrigerant compressed by the first compressor 21. The first expansion valve 23 is configured by, for example, electronic expansion valves (EXV), and decompresses the first refrigerant that has passed through the first heat exchanger 22.

The second heat exchanger 24 is configured by, for example, a chiller, and performs a heat exchange between the first refrigerant that has passed through the first expansion valve 23 and a fourth refrigerant flowing through the second heat exchange circuit 14 to be described later. That is, the second heat exchanger 24 can perform a heat exchange with the first refrigerant that has passed through the first expansion valve 23.

The second refrigeration cycle 12 is a refrigeration cycle that allows a second refrigerant to circulate therethrough, and is operated under the control of the control device 4, for example. Similarly to the first refrigerant described above, the second refrigerant is, for example, an air conditioner refrigerant such as HFC-134a or HFO-1234yf. A solid arrow β illustrated in FIG. 2 indicates a flow direction of the second refrigerant in the second refrigeration cycle 12.

The second refrigeration cycle 12 includes, for example, a second compressor (2nd COMP) 31, a third heat exchanger 32, a second expansion valve 33, and a fourth heat exchanger 34.

The second compressor 31 is configured by, for example, an electric compressor, and compresses and discharges the second refrigerant. The third heat exchanger 32 is configured by, for example, an LCC, and performs a heat exchange between the second refrigerant compressed by the second compressor 31 and a fifth refrigerant flowing through the third heat exchange circuit 15 to be described later. That is, the third heat exchanger 32 can perform a heat exchange with the second refrigerant compressed by the second compressor 31. The second expansion valve 33 is configured by, for example, EXV, and decompresses the second refrigerant that has passed through the third heat exchanger 32.

The fourth heat exchanger 34 is configured by, for example, a chiller, and performs a heat exchange between the second refrigerant that has passed through the second expansion valve 33 and the third refrigerant flowing through the first heat exchange circuit 13. That is, the fourth heat exchanger 34 can perform a heat exchange with the second refrigerant that has passed through the second expansion valve 33.

The first heat exchange circuit 13 is configured to allow the third refrigerant to circulate therethrough, and is configured to be able to perform a heat exchange between the first heat exchanger 22 and the fourth heat exchanger 34 and adjust temperatures of the battery 1 and the drive unit 2 as temperature adjustment targets. The third refrigerant is, for example, a long life coolant (LLC).

More specifically, the first heat exchange circuit 13 includes a battery cooling circuit 13A capable of performing a heat exchange with the first heat exchanger 22, and a drive unit cooling circuit 13B capable of performing a heat exchange with the fourth heat exchanger 34.

The battery cooling circuit 13A includes, for example, the battery 1 and an electric coolant heater (ECH) 41 in addition to the first heat exchanger 22. The third refrigerant in the battery cooling circuit 13A can circulate through the battery cooling circuit 13A in the order of the first heat exchanger 22, the battery 1, and the electric coolant heater 41 by being pumped by the first pump 42 provided in the battery cooling circuit 13A, for example. That is, a solid arrow γ illustrated in FIG. 2 indicates a flow direction of the third refrigerant in the battery cooling circuit 13A. The first pump 42 is provided, for example, in the middle of a flow path for guiding the third refrigerant from the battery 1 to the electric coolant heater 41.

The drive unit cooling circuit 13B includes, for example, the drive unit 2 and a bypass flow path BP provided in parallel with the drive unit 2 in addition to the fourth heat exchanger 34. The third refrigerant in the drive unit cooling circuit 13B can circulate through the drive unit cooling circuit 13B in the order of the fourth heat exchanger 34, the drive unit 2, and/or the bypass flow path BP by being pumped by a second pump 43 provided in the drive unit cooling circuit 13B, for example. The second pump 43 is provided, for example, in the middle of a flow path for guiding the third refrigerant from the fourth heat exchanger 34 to the drive unit 2 and the bypass flow path BP.

In the drive unit cooling circuit 13B, a branch point is provided between the fourth heat exchanger 34 and the drive unit 2 and the bypass flow path BP to split the flow of the third refrigerant from the fourth heat exchanger 34 into the drive unit 2 side and the bypass flow path BP side. The branch point is provided with a flow rate adjustment valve 44 capable of adjusting a flow rate of the third refrigerant to each of the drive unit 2 side and the bypass flow path BP side. The flow rate adjustment valve 44 adjusts the flow rate of the third refrigerant to each of the drive unit 2 side and the bypass flow path BP side, for example, under the control of the control device 4.

The flow rate adjustment valve 44 may set the flow rate of the third refrigerant to the drive unit 2 side to 0 (zero) or may set the flow rate of the third refrigerant to the bypass flow path BP side to 0. In other words, the flow rate adjustment valve 44 may cause all the third refrigerant from the fourth heat exchanger 34 to flow to the bypass flow path BP side, or may cause all the third refrigerant from the fourth heat exchanger 34 to flow to the drive unit 2 side. Further, the flow rate adjustment valve 44 may cause a predetermined amount of the third refrigerant to flow to each of the drive unit 2 side and the bypass flow path BP side.

In the first heat exchange circuit 13, the battery cooling circuit 13A and the drive unit cooling circuit 13B are connected via a flow path switching valve 45. Focusing on the battery cooling circuit 13A, the flow path switching valve 45 is provided in the middle of a flow path for guiding the third refrigerant that has passed through the battery 1 and the electric coolant heater 41 to the first heat exchanger 22. In other words, in the battery cooling circuit 13A, the flow path switching valve 45 is provided downstream of the battery 1 and upstream of the first heat exchanger 22 in the flow direction of the third refrigerant in the battery cooling circuit 13A.

Focusing on the drive unit cooling circuit 13B, the flow path switching valve 45 is provided in the middle of a flow path for guiding the third refrigerant that has passed through the drive unit 2 or the bypass flow path BP to the fourth heat exchanger 34. In other words, in the drive unit cooling circuit 13B, the flow path switching valve 45 is provided downstream of the drive unit 2 and upstream of the fourth heat exchanger 34 in the flow direction of the third refrigerant in the drive unit cooling circuit 13B.

The flow path switching valve 45 is configured to be switchable between a connected state where the third refrigerant can flow between the battery cooling circuit 13A and the drive unit cooling circuit 13B and a shut-off state where the third refrigerant cannot flow therebetween. Switching between the connected state and the shut-off state in the flow path switching valve 45 is controlled by, for example, the control device 4.

When the flow path switching valve 45 is in the connected state, the third refrigerant that has passed through the first heat exchanger 22, the battery 1, and the like of the battery cooling circuit 13A flows into the drive unit cooling circuit 13B via the flow path switching valve 45 and flows to the fourth heat exchanger 34 of the drive unit cooling circuit 13B. When the flow path switching valve 45 is in the connected state, the third refrigerant that has passed through the fourth heat exchanger 34, the drive unit 2, and the like of the drive unit cooling circuit 13B flows into the battery cooling circuit 13A via the flow path switching valve 45 and flows to the first heat exchanger 22 of the battery cooling circuit 13A. Therefore, when the flow path switching valve 45 is in the connected state, the heat exchange via the third refrigerant is performed between the first heat exchanger 22 and the fourth heat exchanger 34.

On the other hand, when the flow path switching valve 45 is in the shut-off state, the third refrigerant of the battery cooling circuit 13A does not flow into the drive unit cooling circuit 13B, and the third refrigerant of the drive unit cooling circuit 13B does not flow into the drive unit cooling circuit 13A. That is, when the flow path switching valve 45 is in the shut-off state, the third refrigerant circulates independently in each of the battery cooling circuit 13A and the drive unit cooling circuit 13B. Therefore, when the flow path switching valve 45 is in the shut-off state, the heat exchange via the third refrigerant is not performed between the first heat exchanger 22 and the fourth heat exchanger 34.

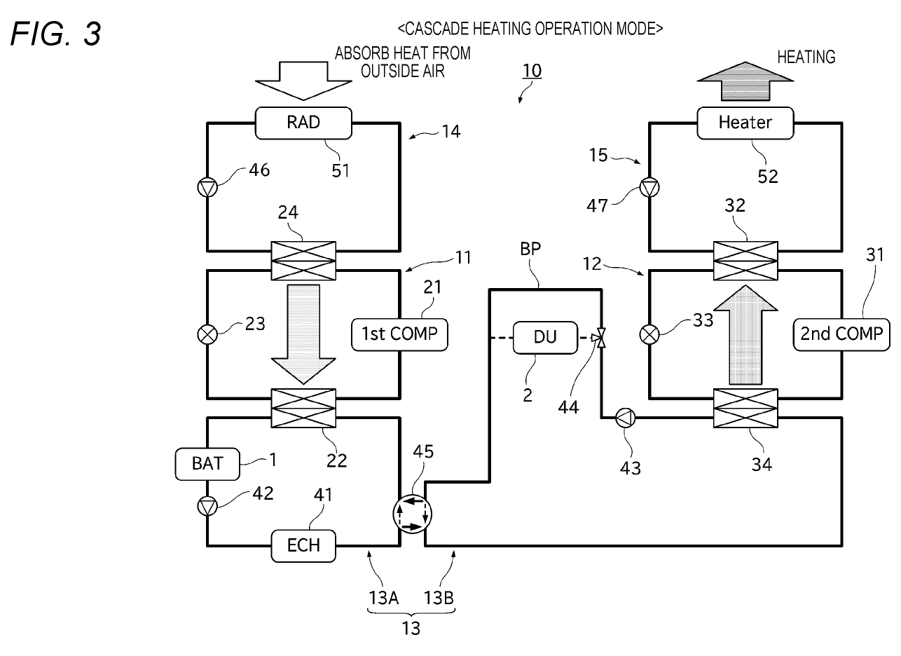

In the present embodiment, a state where the battery 1 as a first drive source of the vehicle V is thermally connected to the first heat exchanger 22 and the fourth heat exchanger 34 is defined as a "first state". As illustrated in FIG. 3, the first state is realized, for example, by allowing the third refrigerant to circulate through the first heat exchange circuit 13 by the first pump 42 and/or the second pump 43 after setting the flow path switching valve 45 to the connected state. In the first state, the first heat exchanger 22, the battery 1, and the fourth heat exchanger 34 are connected in this order in the flow direction of the third refrigerant.

Operation of the first refrigeration cycle 11 and the second refrigeration cycle 12 with the first heat exchange circuit 13 in the first state is hereinafter also referred to as a "cascade heating operation mode". In the cascade heating operation mode, as illustrated in FIG. 3, the temperature adjustment circuit 10 can absorb heat from outside air in the first refrigeration cycle 11 via the second heat exchange circuit 14, and can further absorb the heat in the second refrigeration cycle 12 using the heat absorbed in the first refrigeration cycle 11 as a heat source. Therefore, in the case of the cascade heating operation mode, even when a compression ratio of the first compressor 21 or the second compressor 31 is reduced, the first refrigerant, the second refrigerant, and the third refrigerant can be efficiently heated to a temperature at which the passenger compartment can be heated, as compared with the case where the passenger compartment is heated by the heat absorbed by one refrigeration cycle.

As described above, in the first state (for example, the cascade heating operation mode), the first heat exchanger 22, the battery 1, and the fourth heat exchanger 34 are connected in this order in the flow direction of the third refrigerant. Therefore, in the first state, the heat absorbed in the first refrigeration cycle 11 can be transferred to the fourth heat exchanger 34 and the battery 1 to heat the battery 1.

In the first state, the first heat exchange circuit 13 is configured to be switchable between a state where the drive unit 2 is connected to the first heat exchanger 22 and the fourth heat exchanger 34 (for example, a state where the flow rate of the third refrigerant to the drive unit 2 side set by the flow rate adjustment valve 44 is larger than 0) and a state where the drive unit 2 is not connected to the first heat exchanger 22 and the fourth heat exchanger 34 (for example, a state where the flow rate of the third refrigerant to the drive unit 2 side set by the flow rate adjustment valve 44 is 0). For example, when the drive unit 2 is connected to the first heat exchanger 22 and the fourth heat exchanger 34 in the first heat exchange circuit 13, the drive unit 2 can be heated by operating the first refrigeration cycle 11. On the other hand, when the drive unit 2 is not connected to the first heat exchanger 22 and the fourth heat exchanger 34 in the first heat exchange circuit 13, the drive unit 2 can be prevented from being heated even when the first refrigeration cycle 11 is operated. Therefore, the temperature of the drive unit 2 can be adjusted independently of an operation state of the first refrigeration cycle 11.

In the present embodiment, a state where the drive unit 2 as a second drive source of the vehicle V and the fourth heat exchanger 34 are thermally connected is defined as a "second state". The second state is realized, for example, by setting the flow path switching valve 45 to the shut-off state, causing the third refrigerant from the fourth heat exchanger 34 to flow to the drive unit 2 side by the flow rate adjustment valve 44, and then allowing the third refrigerant to circulate through the drive unit cooling circuit 13B by at least the second pump 43. When the first heat exchange circuit 13 is in the second state, for example, the drive unit 2 can be cooled by absorbing the heat of the drive unit 2 in the second refrigeration cycle 12.

In the second state, a state where the first refrigeration cycle 11 (for example, the first compressor 21) is operated to perform a heat exchange between the battery 1 and the first heat exchanger 22 is defined as a "third state". The third state is hereinafter also referred to as "single-stage heating + low-stage warm-up operation mode".

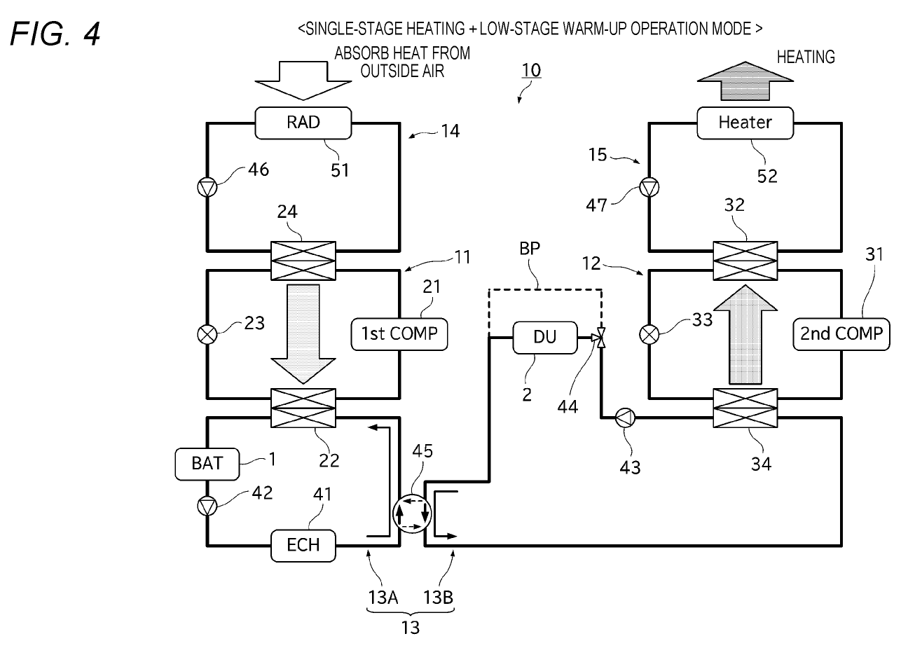

As illustrated in FIG. 4, the third state, that is, the single-stage heating + low-stage warm-up operation mode is realized, for example, by setting the flow path switching valve 45 to the shut-off state, causing the third refrigerant from the fourth heat exchanger 34 to flow to the drive unit 2 side by the flow rate adjustment valve 44, then allowing the third refrigerant to circulate through the battery cooling circuit 13A by the first pump 42, and allowing the third refrigerant to circulate through the drive unit cooling circuit 13B by the second pump 43.

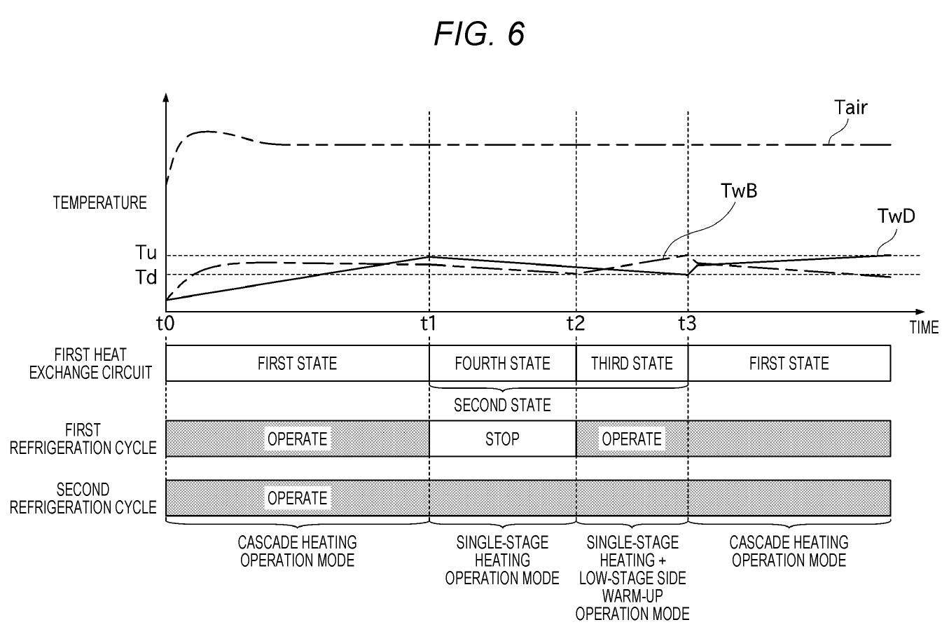

In the third state, that is, in the single-stage heating + low-stage warm-up operation mode, as illustrated in FIG. 4, the temperature adjustment circuit 10 can adjust the temperature of the battery 1 while absorbing the heat from the outside air in the first refrigeration cycle 11 via the second heat exchange circuit 14. Further, the temperature adjustment circuit 10 can adjust the temperature of the drive unit 2 by absorbing the heat of the drive unit 2 in the second refrigeration cycle 12. That is, in the third state (single-stage heating + low-stage warm-up operation mode), the temperature of the battery 1 and the temperature of the drive unit 2 can be adjusted independently of each other. In addition, in the third state (single-stage heating + low-stage warm-up operation mode), since the heat of the drive unit 2 is not transferred to the battery cooling circuit 13A side, it is possible to maintain the temperature of the third refrigerant circulating through the drive unit cooling circuit 13B to be relatively high, for example, to increase the temperature of the drive unit 2 (for example, refer to a period from time t2 to time t3 in FIG. 6 to be described later).

In the second state, a state where the first refrigeration cycle 11 (for example, the first compressor 21) is not operated is defined as a "fourth state". Further, the fourth state is hereinafter also referred to as a "single-stage heating operation mode".

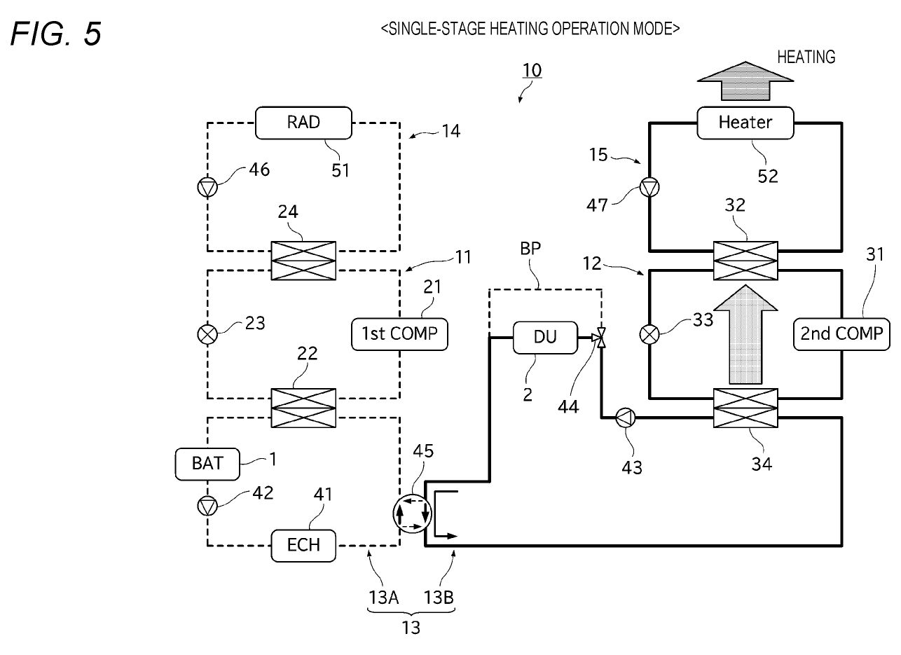

As illustrated in FIG. 5, the fourth state, that is, the single-stage heating operation mode is realized, for example, by setting the flow path switching valve 45 to the shut-off state, causing the third refrigerant from the fourth heat exchanger 34 to flow to the drive unit 2 side by the flow rate adjustment valve 44, and then driving only the second pump 43 of the first pump 42 and the second pump 43 to allow the third refrigerant to circulate through the drive unit cooling circuit 13B.

In the fourth state, that is, in the single-stage heating operation mode, as illustrated in FIG. 5, since the heat of the drive unit 2 is not transferred to the battery cooling circuit 13A side as in the third state (single-stage heating + low-stage warm-up operation mode), and the temperature adjustment circuit 10 can effectively utilize the heat of the drive unit 2 to heat the passenger compartment. Further, in the fourth state (single-stage heating operation mode), by not operating the first refrigeration cycle 11, it is possible to heat the passenger compartment with less power than in a case where the first refrigeration cycle 11 is operated.

As described above, the temperature adjustment circuit 10 (for example, the first heat exchange circuit 13) of the present embodiment is configured to be switchable between the first state and the second state. Further, the temperature adjustment circuit 10 is configured to be switchable between the third state and the fourth state in the second state.

The second heat exchange circuit 14 is configured to allow the fourth refrigerant to circulate therethrough and to perform a heat exchange with the outside air and the second heat exchanger 24 (that is, the first refrigerant circulating through the first refrigeration cycle 11). More specifically, the second heat exchange circuit 14 includes, for example, a radiator 51 (in other words, a fifth heat exchanger) as a heat exchanger that performs a heat exchange between the fourth refrigerant circulating through the second heat exchange circuit 14 and the outside air, in addition to the second heat exchanger 24. The fourth refrigerant is, for example, LLC.

The fourth refrigerant in the second heat exchange circuit 14 circulates through the second heat exchange circuit 14 in the order of the second heat exchanger 24 and the radiator 51, for example, by being pumped by a third pump 46 provided in the second heat exchange circuit 14. That is, a solid arrow δ illustrated in FIG. 2 indicates a flow direction of the fourth refrigerant in the second heat exchange circuit 14. The third pump 46 is provided, for example, in the middle of a flow path for guiding the fourth refrigerant from the radiator 51 to the second heat exchanger 24.

The third heat exchange circuit 15 is configured to allow the fifth refrigerant to circulate therethrough and to perform a heat exchange with the third heat exchanger 32 (that is, the second refrigerant circulating through the second refrigeration cycle 12). More specifically, the third heat exchange circuit 15 includes, for example, a heater 52 that heats the passenger compartment in addition to the third heat exchanger 32. The heater 52 includes, for example, a heater core (or a cabin condenser), and heats the passenger compartment by performing a heat exchange with the fifth refrigerant that has passed through the third heat exchanger 32. The fifth refrigerant is, for example, LLC.

The fifth refrigerant in the third heat exchange circuit 15 circulates through the third heat exchange circuit 15 in the order of the third heat exchanger 32 and the heater 52, for example, by being pumped by a fourth pump 47 provided in the third heat exchange circuit 15. That is, a solid arrow ε illustrated in FIG. 2 indicates a flow direction of the fifth refrigerant in the third heat exchange circuit 15. The fourth pump 47 is provided, for example, in the middle of a flow path for guiding the fifth refrigerant from the heater 52 to the third heat exchanger 32.

### Specific Control Example of Temperature Adjustment Circuit by Control Device

Next, a specific control example of the temperature adjustment circuit 10 by the control device 4 will be described. The control device 4 can switch between the first state and the second state described above and switch between the operation states of the first refrigeration cycle 11 and the second refrigeration cycle 12. For example, the control device 4 switches between the first state and the second state based on the state of the battery 1 (first drive source) or the drive unit 2 (second drive source).

More specifically, the control device 4 switches between the first state and the second state (that is, the third state or the fourth state) based on a temperature TwD of the drive unit 2, and switches between the third state and the fourth state based on a temperature TwB of the battery 1. Through such state transition, the control device 4 adjusts a blowing temperature Tair of the HVAC 3 to heat the passenger compartment while adjusting the temperatures of the battery 1 and the drive unit 2 to appropriate temperatures.

Here, the temperature TwD of the drive unit 2 can be regarded as, for example, the temperature of the third refrigerant circulating through the drive unit cooling circuit 13B. Therefore, the control device 4 can acquire the temperature TwD as the state of the drive unit 2 based on, for example, a detection result of a water temperature sensor (not illustrated) provided in the drive unit cooling circuit 13B.

Here, the temperature TwB of the battery 1 can be regarded as, for example, the temperature of the third refrigerant circulating through the battery cooling circuit 13A. Therefore, the control device 4 can acquire the temperature TwB as the state of the battery 1 based on, for example, a detection result of a water temperature sensor (not illustrated) provided in the battery cooling circuit 13A.

FIG. 6 illustrates an example of specific control of the temperature adjustment circuit 10 by the control device 4. As illustrated in FIG. 6, for example, the control device 4 sets the first heat exchange circuit 13 to the first state and operates the first refrigeration cycle 11 and the second refrigeration cycle 12 (that is, the cascade heating operation mode) from time t0 when both the temperature TwD of the drive unit 2 and the temperature TwB of the battery 1 are lower than a predetermined lower threshold Td, thereby quickly increasing the blowing temperature Tair of the HVAC 3 to enable heating of the passenger compartment. As illustrated in FIG. 6, in the cascade heating operation mode, the temperature TwD of the drive unit 2 may gradually increase. On the other hand, in the cascade heating operation mode, the temperature TwB of the battery 1 may gradually decrease after temporarily increasing to a predetermined temperature.

The control device 4 switches the first heat exchange circuit 13 from the first state to the second state at time t1 when the temperature TwD of the drive unit 2 reaches a predetermined upper threshold Tu. More specifically, when switching to the second state, the control device 4 first sets the single-stage heating operation mode. That is, the control device 4 sets the first heat exchange circuit 13 to the fourth state, operates the second refrigeration cycle 12, and stops the first refrigeration cycle 11. As illustrated in FIG. 6, in the single-stage heating operation mode, the temperature TwD of the drive unit 2 and the temperature TwB of the battery 1 may gradually decrease.

Then, at time t2 when the temperature TwB of the battery 1 reaches the lower threshold Td, the control device 4 sets the single-stage heating + low-stage side warm-up mode. That is, the control device 4 sets the first heat exchange circuit 13 to the third state and operates the first refrigeration cycle 11 and the second refrigeration cycle 12. As illustrated in FIG. 6, in the single-stage heating + low-stage side warm-up mode, the temperature TwB of the battery 1 may gradually increase, while the temperature TwD of the drive unit 2 may gradually decrease.

Then, from time t3 when the temperature TwD of the drive unit 2 reaches the lower threshold Td, the control device 4 sets the first heat exchange circuit 13 to the first state and operates the first refrigeration cycle 11 and the second refrigeration cycle 12 to switch to the cascade heating operation mode. Accordingly, as illustrated in FIG. 6, the temperature TwD of the drive unit 2 can be increased again.

By performing such control, the control device 4 can heat the passenger compartment while maintaining the temperature TwD of the drive unit 2 and the temperature TwB of the battery 1 at appropriate temperatures. Specifically, the control device 4 can maintain the temperature TwD of the drive unit 2 at an appropriate temperature (Tu ≥ TwD ≥ Td) by switching between the first state (cascade heating operation mode) and the second state (single-stage heating operation mode or single-stage heating + low-stage side warm-up mode) based on the temperature TwD of the drive unit 2.

In addition, the control device 4 can maintain the temperature TwB of the battery 1 at an appropriate temperature (Tu ≥ TwB ≥ Td) by switching between the third state (single-stage heating + low-stage side warm-up mode) and the fourth state (single-stage heating operation mode) based on the temperature TwB of the battery 1. Further, the temperature TwB of the battery 1 can be maintained more efficiently and appropriately by switching from the fourth state (single-stage heating operation mode) in which the temperature TwB of the battery 1 may decrease to the first state (cascade heating operation mode) in which the temperature TwB of the battery 1 may decrease via the third state (single-stage heating + low-stage side warm-up mode) in which the temperature TwB of the battery 1 may increase.

### Processing Executed by Control Device

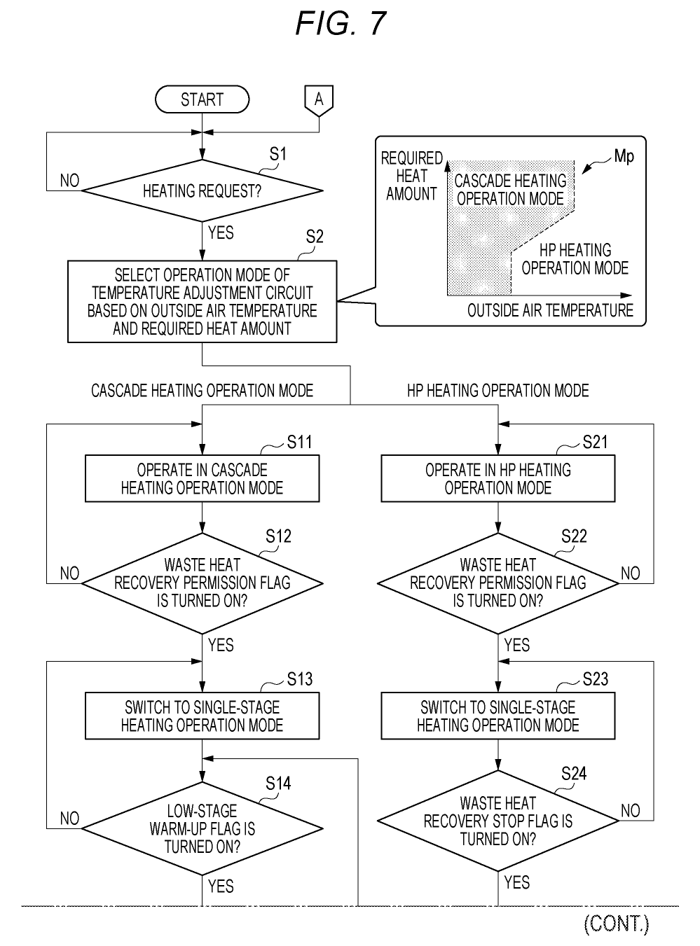

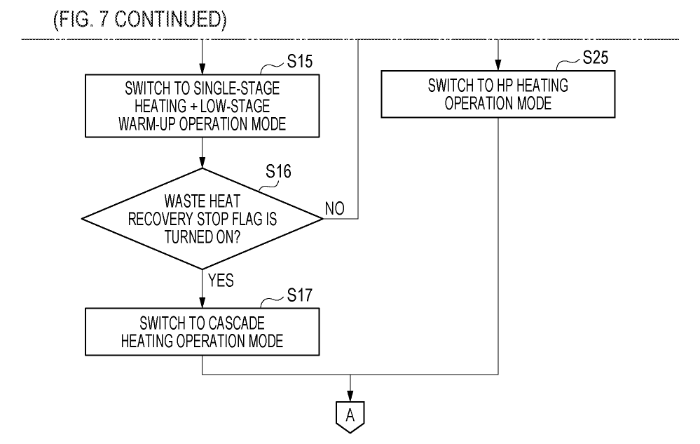

Next, an example of processing executed by the control device 4 will be described with reference to FIG. 7. For example, when an ignition power supply of the vehicle V is turned on, the control device 4 executes a series of processing illustrated in FIG. 7.

As illustrated in FIG. 7, the control device 4 first waits until there is a heating request for the passenger compartment (step S1: NO). If there is a heating request for the passenger compartment (step S1: YES), the control device 4 selects the operation mode of the temperature adjustment circuit 10 based on an outside air temperature around the vehicle V and a required heat amount (step S2). In the processing of step S2, for example, the control device 4 selects the operation mode of the temperature adjustment circuit 10 based on the outside air temperature and the required heat amount with reference to an operation mode selection map Mp stored in advance in the control device 4.

As illustrated in FIG. 7, for example, when the outside air temperature is relatively low, or when the outside air temperature is relatively low and the required heat amount is relatively large, the control device 4 may select the cascade heating operation mode as the operation mode of the temperature adjustment circuit 10. On the other hand, for example, when the outside air temperature is relatively high or when the outside air temperature is relatively high and the required heat amount is relatively small, the control device 4 can select a heat pump (HP) heating operation mode as the operation mode of the temperature adjustment circuit 10. Here, the required heat amount is, for example, a sum of heat amounts required for warming up the battery 1 and heating the passenger compartment.

When the cascade heating operation mode is selected in the processing of step S2 (step S2: cascade heating operation mode), the control device 4 operates the temperature adjustment circuit 10 in the cascade heating operation mode (step S11).

Next, the control device 4 determines whether a waste heat recovery permission flag is turned on (step S12). Here, the waste heat recovery permission flag is, for example, a flag that is turned on when the temperature TwD of the drive unit 2 reaches the upper threshold Tu.

If the waste heat recovery permission flag is determined to be off (step S12: NO), the control device 4 returns to the processing of step S11 and continues the operation in the cascade heating operation mode. On the other hand, if the waste heat recovery permission flag is determined to be on (step S12: YES), the control device 4 switches the operation mode of the temperature adjustment circuit 10 to the single-stage heating operation mode (step S13).

Next, the control device 4 determines whether a low-stage warm-up flag is turned on (step S14). Here, the low-stage warm-up flag is, for example, a flag that is turned on when the temperature TwB of the battery 1 reaches the lower threshold Td.

If the low-stage warm-up flag is determined to be off (step S14: NO), the control device 4 returns to the processing of step S13 and continues the operation in the single-stage heating operation mode. On the other hand, if the low-stage warm-up flag is determined to be on (step S14: YES), the control device 4 switches the operation mode of the temperature adjustment circuit 10 to the single-stage heating + low-stage side warm-up mode (step S15).

Next, the control device 4 determines whether a waste heat recovery stop flag is turned on (step S16). Here, the waste heat recovery stop flag is, for example, a flag that is turned on when the temperature TwD of the drive unit 2 reaches the lower threshold Td.

If the waste heat recovery stop flag is determined to be off (step S16: NO), the control device 4 returns to the processing of step S14. On the other hand, if the waste heat recovery stop flag is determined to be on (step S16: YES), the control device 4 switches the operation mode of the temperature adjustment circuit 10 to the cascade heating operation mode (step S17), and returns to the processing of step S1.

When the HP heating operation mode is selected in the processing of step S2 (step S2: HP heating operation mode), the control device 4 operates the temperature adjustment circuit 10 in the HP heating operation mode (step S21). The HP heating operation mode is, for example, the same as the single-stage heating + low-stage warm-up operation mode in terms of the state of the temperature adjustment circuit 10. That is, the HP heating operation mode may be replaced with the single-stage heating + low-stage warm-up operation mode. In the HP heating operation mode (that is, the single-stage heating + low-stage warm-up operation mode), for example, the temperature adjustment circuit 10 can heat the passenger compartment by absorbing heat from a periphery (for example, the outside air) of the drive unit cooling circuit 13B or the second refrigeration cycle 12 in the second refrigeration cycle 12, and transferring the heat to the third heat exchange circuit 15.

Next, the control device 4 determines whether the waste heat recovery permission flag is turned on (step S22). If the waste heat recovery permission flag is determined to be off (step S22: NO), the control device 4 returns to the processing of step S21 and continues the operation in the HP heating operation mode. On the other hand, if the waste heat recovery permission flag is determined to be on (step S22: YES), the control device 4 switches the operation mode of the temperature adjustment circuit 10 to the single-stage heating operation mode (step S23).

Next, the control device 4 determines whether the waste heat recovery stop flag is turned on (step S24). If the waste heat recovery stop flag is determined to be off (step S24: NO), the control device 4 returns to the processing of step S23. On the other hand, if the waste heat recovery stop flag is determined to be on (step S23: YES), the control device 4 switches the operation mode of the temperature adjustment circuit 10 to the HP heating operation mode (step S25), and returns to the processing of step S1.

### Effects of Present Embodiment

As described above, the temperature adjustment circuit 10 of the present embodiment includes the first heat exchange circuit 13 capable of performing the heat exchange between the first heat exchanger 22 of the first refrigeration cycle 11 and the fourth heat exchanger 34 of the second refrigeration cycle 12, and the battery 1 and/or the drive unit 2 as a temperature adjustment target of which temperature is adjusted by the first heat exchange circuit 13. Therefore, according to the temperature adjustment circuit 10, it is possible to adjust the temperature of the battery 1 and/or the drive unit 2 while performing the heat exchange between the first refrigeration cycle 11 and the second refrigeration cycle 12 by the first heat exchange circuit 13. Accordingly, since the first refrigeration cycle 11 and the second refrigeration cycle 12 can be operated in consideration of the states (for example, the temperatures) of the battery 1 and the drive unit 2, the operation efficiency of the first refrigeration cycle 11 and the second refrigeration cycle 12 can be improved. By extension, it is possible to contribute to improvement of energy efficiency.

As an example, the third refrigerant circulating in the second refrigeration cycle 12 can be heated by using the heat of the battery 1 in addition to the heat collected in the first refrigeration cycle 11. As another example, the drive unit 2 can be heated by operating the first refrigeration cycle 11, and the drive unit 2 can be cooled by operating the second refrigeration cycle 12.

The temperature adjustment circuit 10 of the present embodiment is mounted on the vehicle V, which is an example of a moving object. The temperature adjustment target of which temperature is adjusted by the first heat exchange circuit 13 is the battery 1 and/or the drive unit 2, which are the drive sources of the vehicle V. Accordingly, according to the temperature adjustment circuit 10, it is possible to maintain the battery 1 and/or the drive unit 2, which are drive sources of the vehicle V, at an appropriate temperature.

In the temperature adjustment circuit 10 of the present embodiment, the first heat exchange circuit 13 is configured to be switchable between the first state (for example, the cascade heating operation mode) and the second state (for example, the single-stage heating + low-stage warm-up operation mode or the single-stage heating operation mode). Therefore, according to the temperature adjustment circuit 10, by setting the first heat exchange circuit 13 to the second state, it is possible to thermally separate the first refrigeration cycle 11 from the first heat exchange circuit 13. Accordingly, it is possible to efficiently operate the temperature adjustment circuit 10 by switching the state of the first heat exchange circuit 13 according to the necessity of operating the first refrigeration cycle 11.

In the temperature adjustment circuit 10 of the present embodiment, when the first heat exchange circuit 13 is in the first state, the first heat exchanger 22, the battery 1 as the first drive source of the vehicle V, and the fourth heat exchanger 34 are connected in this order. On the other hand, when the first heat exchange circuit 13 is in the second state, the drive unit 2 as the second drive source of the vehicle V and the fourth heat exchanger 34 are connected. Therefore, according to the temperature adjustment circuit 10, when the first heat exchange circuit 13 is in the first state, the heat absorbed in the first refrigeration cycle 11 can be transferred to the fourth heat exchanger 34 and the battery 1 to heat the battery 1. When the first heat exchange circuit 13 is in the second state, the drive unit 2 can be cooled by absorbing the heat of the drive unit 2 in the second refrigeration cycle 12.

The temperature adjustment circuit 10 of the present embodiment further includes the control device 4 capable of switching the first heat exchange circuit 13 between the first state and the second state and switching the operation states (operation/stop) of the first refrigeration cycle 11 and the second refrigeration cycle 12. The control device 4 switches the first heat exchange circuit 13 between the first state and the second state based on the state of the drive unit 2 (for example, the temperature TwD of the drive unit 2).

That is, for example, the temperature TwD of the drive unit 2 may increase when the first heat exchange circuit 13 is in the first state, and the temperature TwD of the drive unit 2 may decrease when the first heat exchange circuit 13 is in the second state. According to the temperature adjustment circuit 10, the control device 4 switches the first heat exchange circuit 13 between the first state and the second state based on the state of the drive unit 2, so that the drive unit 2 can be maintained at an appropriate temperature, and for example, the temperature TwD of the drive unit 2 can be prevented from excessively decreasing.

In the temperature adjustment circuit 10 of the present embodiment, in the first state, the first heat exchange circuit 13 is configured to be switchable between a state where the drive unit 2 is connected to the first heat exchanger 22 and the fourth heat exchanger 34 (for example, a state where the flow rate of the third refrigerant to the drive unit 2 side set by the flow rate adjustment valve 44 is larger than 0) and a state where the drive unit 2 is not connected to the first heat exchanger 22 and the fourth heat exchanger 34 (for example, a state where the flow rate of the third refrigerant to the drive unit 2 side set by the flow rate adjustment valve 44 is 0).

Therefore, according to the temperature adjustment circuit 10, when the drive unit 2 is connected to the first heat exchanger 22 and the fourth heat exchanger 34 in the first heat exchange circuit 13, the drive unit 2 can be heated by operating the first refrigeration cycle 11. When the drive unit 2 is not connected to the first heat exchanger 22 and the fourth heat exchanger 34 in the first heat exchange circuit 13, the drive unit 2 can be prevented from being heated even when the first refrigeration cycle 11 is operated. Therefore, the temperature of the drive unit 2 can be adjusted independently of the operation state of the first refrigeration cycle 11.

Further, in the temperature adjustment circuit 10 of the present embodiment, in the first state, the battery 1 is disposed upstream of the drive unit 2 in the flow direction of the third refrigerant viewed from the first heat exchanger 22 in a state where the drive unit 2 is connected to the first heat exchanger 22 and the fourth heat exchanger 34. Therefore, in the first heat exchange circuit 13, even in a state where the drive unit 2 is connected to the first heat exchanger 22 and the fourth heat exchanger 34, that is, even in a state where the drive unit 2 can be heated by operating the first refrigeration cycle 11, since the battery 1 is disposed upstream of the drive unit 2, it is possible to more actively heat the battery 1 than the drive unit 2. In addition, in the first heat exchange circuit 13, since it is possible to select the state where the drive unit 2 is connected to the first heat exchanger 22 and the fourth heat exchanger 34 and the state where the drive unit 2 is not connected to the first heat exchanger 22 and the fourth heat exchanger 34, when heating of the drive unit 2 is unnecessary, it is possible to actively distribute heat to the battery 1 by selecting the state where the drive unit 2 is not connected to the first heat exchanger 22 and the fourth heat exchanger 34.

In the temperature adjustment circuit 10 of the present embodiment, in the second state, the first heat exchange circuit 13 is configured to be switchable between the third state (for example, the single-stage heating + low-stage warm-up operation mode) in which the first refrigeration cycle 11 is operated to perform a heat exchange between the battery 1 and the first heat exchanger 22 and the fourth state (for example, the single-stage heating operation mode) in which the first refrigeration cycle 11 is not operated. Therefore, according to the temperature adjustment circuit 10, in the second state where the drive unit 2 and the fourth heat exchanger 34 are connected, the third state where the first refrigeration cycle 11 is operated to perform the heat exchange between the battery 1 and the first heat exchanger 22 and the fourth state where the first refrigeration cycle 11 is not operated can be switched, so that the temperature TwB of the battery 1 can be adjusted independently of the temperature TwD of the drive unit 2.

Further, the temperature adjustment circuit 10 of the present embodiment includes the control device 4 capable of switching between the first to fourth states and switching the operation states of the first refrigeration cycle 11 and the second refrigeration cycle 12. The control device 4 switches between the third state and the fourth state based on the state of the battery 1 (for example, the temperature TwB of the battery 1). Therefore, according to the temperature adjustment circuit 10, the control device 4 can maintain the battery 1 at an appropriate temperature by switching between the third state and the fourth state based on the state of the battery 1.

Further, in the temperature adjustment circuit 10 of the present embodiment, the control device 4 can switch from the fourth state to the first state via the third state. That is, the temperature TwB of the battery 1 may decrease when the first heat exchange circuit 13 is in the first state and the fourth state, and the temperature TwB of the battery 1 may increase when the first heat exchange circuit 13 is in the third state. According to the temperature adjustment circuit 10, the control device 4 switches from the fourth state to the first state via the third state, so that the battery 1 can be maintained at an appropriate temperature, and for example, the temperature TwB of the battery 1 can be prevented from excessively decreasing.

Although an embodiment of the present disclosure has been described, it goes without saying that the present invention is not limited to such an example. It is apparent to those skilled in the art that various changes or modifications can be conceived within the scope described in the claims, and it is understood that the changes or modifications naturally fall within the technical scope of the present invention. In addition, respective constituent elements in the above-described embodiment may be freely combined without departing from the gist of the invention.

For example, in the embodiment described above, an example in which the moving object in the present invention is the vehicle V which is an electric vehicle has been described, but the present invention is not limited thereto. The present invention is also applicable to a gasoline automobile, a diesel automobile, or a hybrid electrical vehicle including an internal combustion engine (engine) as a drive source instead of or in addition to the motor M described above. The moving object in the present invention may be an electric vertical take-off and landing aircraft (eVTOL) or the like.

In the present description, at least the following matters are described. In the parentheses, the corresponding constituent elements and the like in the above embodiment are illustrated, but the present invention is not limited thereto.

(1) A temperature adjustment circuit (temperature adjustment circuit 10) having:

a first refrigeration cycle (first refrigeration cycle 11) including:

a first compressor (first compressor 21) configured to compress and discharge a first refrigerant;

a first heat exchanger (first heat exchanger 22) configured to perform a heat exchange with the first refrigerant compressed by the first compressor;

a first expansion valve (first expansion valve 23) configured to decompress the first refrigerant that has passed through the first heat exchanger; and

a second heat exchanger (second heat exchanger 24) configured to perform a heat exchange with the first refrigerant that has passed through the first heat exchanger;

a second refrigeration cycle (second refrigeration cycle 12) including:

a second compressor (second compressor 31) configured to compress and discharge a second refrigerant;

a third heat exchanger (third heat exchanger 32) configured to perform a heat exchange with the second refrigerant compressed by the second compressor;

a second expansion valve (second expansion valve 33) configured to decompress the second refrigerant that has passed through the third heat exchanger; and

a fourth heat exchanger (fourth heat exchanger 34) configured to perform a heat exchange with the second refrigerant that has passed through the third heat exchanger;

a first heat exchange circuit (first heat exchange circuit 13) configured to perform a heat exchange between the first heat exchanger and the fourth heat exchanger; and

a temperature adjustment target (battery 1, drive unit 2) of which temperature is adjusted by the first heat exchange circuit.

According to (1), the temperature of the temperature adjustment target can be adjusted while the heat exchange is performed between the first refrigeration cycle and the second refrigeration cycle by the first heat exchange circuit. Accordingly, the first refrigeration cycle and the second refrigeration cycle can be operated in consideration of the temperature of the temperature adjustment target, and thus the operation efficiency of the first refrigeration cycle and the second refrigeration cycle can be improved.

As an example, the refrigerant circulating in the second refrigeration cycle can be heated by using the heat of the temperature adjustment target in addition to the heat collected in the first refrigeration cycle. As another example, the temperature adjustment target can be heated by operating the first refrigeration cycle, and the temperature adjustment target can be cooled by operating the second refrigeration cycle.

(2) The temperature adjustment circuit according to (1), in which

the temperature adjustment circuit is mounted on a moving object (vehicle V), and

the temperature adjustment target of which temperature is adjusted by the first heat exchange circuit is a drive source (battery 1, drive unit 2) of the moving object.

According to (2), it is possible to maintain the drive source of the moving object at an appropriate temperature by the temperature adjustment circuit.

(3) The temperature adjustment circuit according to (2), in which

the first heat exchange circuit is configured to be switchable between

a first state where the drive source is connected to the first heat exchanger and the fourth heat exchanger, and

a second state where the drive source is connected to the fourth heat exchanger.

According to (3), the first heat exchange circuit is configured to be switchable between the first state and the second state, and thus it is possible to thermally separate the first refrigeration cycle from the first heat exchange circuit by setting the first heat exchange circuit to the second state. Accordingly, it is possible to efficiently operate the temperature adjustment circuit by switching the state of the first heat exchange circuit according to the necessity of operating the first refrigeration cycle.

(4) The temperature adjustment circuit according to (3), in which

the drive source includes a first drive source and a second drive source, and

in the first heat exchange circuit,

in the first state, the first heat exchanger, the first drive source, and the fourth heat exchanger are connected in this order, and

in the second state, the second drive source and the fourth heat exchanger are connected.

According to (4), when the first heat exchange circuit is in the first state, the heat absorbed by the first refrigeration cycle can be transferred to the fourth heat exchanger and the first drive source to heat the first drive source. When the first heat exchange circuit is in the second state, the second drive source can be cooled by the second refrigeration cycle absorbing the heat of the second drive source.

(5) The temperature adjustment circuit according to (4), in which

the temperature adjustment circuit further includes a control device (control device 4) configured to be

switchable between the first state and the second state, and

switchable between operation states of the first refrigeration cycle and the second refrigeration cycle, and

the control device is configured to switch between the first state and the second state based on a state of the second drive source.

For example, a temperature of the second drive source may increase when the first heat exchange circuit is in the first state, and a temperature of the second drive source may decrease when the first heat exchange circuit is in the second state. According to (5), the control device switches the first heat exchange circuit between the first state and the second state based on the state of the second drive source, so that the second drive source can be maintained at an appropriate temperature, and for example, the temperature of the second drive source can be prevented from excessively decreasing.

(6) The temperature adjustment circuit according to (4) or (5), in which

in the first state, the first heat exchange circuit is configured to be switchable between

a state where the second drive source is connected to the first heat exchanger and the fourth heat exchanger, and

a state where the second drive source is not connected to the first heat exchanger and the fourth heat exchanger.

According to (6), in the first heat exchange circuit, when the second drive source is connected to the first heat exchanger and the fourth heat exchanger, the second drive source can be heated by operating the first refrigeration cycle. In the first heat exchange circuit, when the second drive source is not connected to the first heat exchanger and the fourth heat exchanger, the second drive source can be prevented from being heated even when the first refrigeration cycle is operated. Therefore, the temperature of the second drive source can be adjusted independently of the operation state of the first refrigeration cycle.

(7) The temperature adjustment circuit according to (6), in which

in the first state,

the first drive source is disposed upstream of the second drive source in a flow direction of a refrigerant viewed from the first heat exchanger in a state where the second drive source is connected to the first heat exchanger and the fourth heat exchanger.

According to (7), in the first heat exchange circuit, even in a state where the second drive source is connected to the first heat exchanger and the fourth heat exchanger, that is, even in a state where the second drive source can be heated by operating the first refrigeration cycle, since the first drive source is disposed upstream of the second drive source, it is possible to more actively heat the first drive source than the second drive source. In addition, in the first heat exchange circuit, since it is possible to select the state where the second drive source is connected to the first heat exchanger and the fourth heat exchanger and the state where the second drive source is not connected to the first heat exchanger and the fourth heat exchanger, when heating of the second drive source is unnecessary, it is possible to actively distribute heat to the first drive source by selecting the state where the second drive source is not connected to the first heat exchanger and the fourth heat exchanger.

(8) The temperature adjustment circuit according to (4) or (5), in which

in the second state, the first heat exchange circuit is configured to be switchable between

a third state where the first refrigeration cycle is operated to perform a heat exchange between the first drive source and the first heat exchanger, and

a fourth state where the first refrigeration cycle is not operated.

According to (8), in the second state where the second drive source and the fourth heat exchanger are connected, the third state where the first refrigeration cycle is operated to perform the heat exchange between the first drive source and the first heat exchanger and the fourth state where the first refrigeration cycle is not operated can be switched, so that a temperature of the first drive source can be adjusted independently of the temperature of the second drive source.

(9) The temperature adjustment circuit according to (8), in which

the temperature adjustment circuit further includes a control device configured to be

switchable between the first to fourth states, and

switchable between operation states of the first refrigeration cycle and the second refrigeration cycle, and

the control device is configured to switch between the third state and the fourth state based on a state of the first drive source.

According to (9), the control device switches between the third state and the fourth state based on the state of the first drive source, so that the first drive source can be maintained at an appropriate temperature.

(10) The temperature adjustment circuit according to (9), in which

the control device is configured to switch from the fourth state to the first state via the third state.

The temperature of the first drive source may decrease when the first heat exchange circuit is in the first state and the fourth state, and the temperature of the first drive source may increase when the first heat exchange circuit is in the third state. According to (10), the control device switches from the fourth state to the first state via the third state, so that the first drive source can be maintained at an appropriate temperature, and for example, the temperature of the first drive source can be prevented from excessively decreasing.

What is claimed is:

1. A temperature adjustment circuit comprising:
a first refrigeration cycle including:
a first compressor configured to compress and discharge a first refrigerant;
a first heat exchanger configured to perform a heat exchange with the first refrigerant compressed by the first compressor;
a first expansion valve configured to decompress the first refrigerant that has passed through the first heat exchanger; and
a second heat exchanger configured to perform a heat exchange with the first refrigerant that has passed through the first heat exchanger;
a second refrigeration cycle including:
a second compressor configured to compress and discharge a second refrigerant;
a third heat exchanger configured to perform a heat exchange with the second refrigerant compressed by the second compressor;
a second expansion valve configured to decompress the second refrigerant that has passed through the third heat exchanger; and
a fourth heat exchanger configured to perform a heat exchange with the second refrigerant that has passed through the third heat exchanger;
a first heat exchange circuit configured to perform a heat exchange between the first heat exchanger and the fourth heat exchanger; and
a temperature adjustment target of which temperature is adjusted by the first heat exchange circuit.

2. The temperature adjustment circuit according to claim 1, wherein
the temperature adjustment circuit is mounted on a moving object, and
the temperature adjustment target of which temperature is adjusted by the first heat exchange circuit is a drive source of the moving object.

3. The temperature adjustment circuit according to claim 2, wherein
the first heat exchange circuit is configured to be switchable between
a first state where the drive source is connected to the first heat exchanger and the fourth heat exchanger, and
a second state where the drive source is connected to the fourth heat exchanger.

4. The temperature adjustment circuit according to claim 3, wherein
the drive source includes a first drive source and a second drive source, and
in the first heat exchange circuit,
in the first state, the first heat exchanger, the first drive source, and the fourth heat exchanger are connected in this order, and
in the second state, the second drive source and the fourth heat exchanger are connected.

5. The temperature adjustment circuit according to claim 4, wherein
the temperature adjustment circuit further comprises a control device configured to be
switchable between the first state and the second state, and
switchable between operation states of the first refrigeration cycle and the second refrigeration cycle, and
the control device is configured to switch between the first state and the second state based on a state of the second drive source.

6. The temperature adjustment circuit according to claim 4, wherein
in the first state, the first heat exchange circuit is configured to be switchable between
a state where the second drive source is connected to the first heat exchanger and the fourth heat exchanger, and
a state where the second drive source is not connected to the first heat exchanger and the fourth heat exchanger.

7. The temperature adjustment circuit according to claim 6, wherein
in the first state,
the first drive source is disposed upstream of the second drive source in a flow direction of a refrigerant viewed from the first heat exchanger in a state where the second drive source is connected to the first heat exchanger and the fourth heat exchanger.

8. The temperature adjustment circuit according to claim 4, wherein
in the second state, the first heat exchange circuit is configured to be switchable between
a third state where the first refrigeration cycle is operated to perform a heat exchange between the first drive source and the first heat exchanger, and
a fourth state where the first refrigeration cycle is not operated.

9. The temperature adjustment circuit according to claim 8, wherein
the temperature adjustment circuit further comprises a control device configured to be
switchable between the first to fourth states, and
switchable between operation states of the first refrigeration cycle and the second refrigeration cycle, and
the control device is configured to switch between the third state and the fourth state based on a state of the first drive source.

10. The temperature adjustment circuit according to claim 9, wherein
the control device is configured to switch from the fourth state to the first state via the third state.
